(19) United States
(12) Patent Application Publication
(10) Pub. No.: US 2024/0097155 A1
(43) Pub. Date: Mar. 21, 2024

(54) BURNER DEVICE FOR A FUEL CELL SYSTEM

(71) Applicant: AVL List GmbH, Graz (AT)

(72) Inventors: Raphael NEUBAUER, Graz (AT); Bernd REITER, Kainbach bei Graz (AT); Christoph SCHLUCKNER, Werndorf (AT)

(73) Assignee: AVL List GmbH, Graz (AT)

(21) Appl. No.: 18/038,456

(22) PCT Filed: Nov. 23, 2021
(86) PCT No.: PCT/AT2021/060442

§ 371 Date: May 24, 2023

(30) Foreign Application Priority Data
Nov. 24, 2020 (AT) A51019/2020

(51) Int. Cl. H01M 8/04014; F23R 3/40; H01M 8/04746

(52) U.S. Cl. CPC H01M 8/04022; F23R 3/40; H01M 8/04776

(57) ABSTRACT

The present invention relates to a burner device (10) for a fuel cell system (100), having a burner housing (20) with a burner inlet (22) for admitting a fuel/air mixture (BL) and a burner outlet (24) for discharging a burner exhaust gas/air mixture (BAL), additionally having a catalyst body (30) within the burner housing (20) comprising a catalyst cavity (32) into which the burner inlet (22) opens, wherein the catalyst body (30) is gas-permeable and has a catalyst surface (34) with an at least partly catalytic coating (36), wherein a bypass volume (40) is formed between the catalyst surface (34) and the burner housing (20), said bypass volume opening into the burner outlet (24), wherein the catalyst body (30) additionally has a longitudinal axis (LA), and the catalyst surface (34) has a cross-sectional contour (QK) which deviates from a circular shape at least in some sections with respect to the longitudinal axis (LA).

The present invention relates to a burner device for a fuel cell system and a fuel cell system with such a burner device.

It is known that fuel cell systems have burner devices which provide energy in the form of heat, in particular when heating up the fuel cell system. In normal operation of the fuel cell system, such burner devices can be used as afterburners for the aftertreatment of the exhaust gas and/or as preburners. In known fuel cell systems, two different burner concepts are used for heating up in a start-up phase of the fuel cell system. On the one hand there are flame burners and on the other hand so-called catalytic burners.

In catalytic burners, a fuel fluid flows through a catalyst body and catalytic combustion thereby takes place. This catalytic combustion generates heat, which is then supplied to the fuel cell system and in particular to the fuel cell stack. However, a disadvantage of such purely catalytically acting burners is their relatively low efficiency and their slow heating speed.

It is also known for flame burners to be used, i.e. burners which burn a fuel/air mixture, forming a flame, and in this way also generate heat which is introduced into the fuel cell stack of the fuel cell system. However, a disadvantage of the flame burners is that they can only be operated in a stable manner with great effort, especially in heating-up operation. In particular, this is due to the fact that very high mass flows of the individual fluids are at some times required when heating up a fuel cell system. This in turn leads to high flow velocities, in particular in a burner device, so that there is a risk that the flame may be blown out again following ignition, thus stopping the heating process in an undesirable way. This disadvantage is usually countered through complex design measures to protect a flame from being blown out once ignited. In addition to the complex design measures, this leads to a high installation space requirement and correspondingly high weight and high costs for such a burner device.

It is the object of the present invention to remedy, at least partially, the disadvantages described above. In particular, it is the object of the present invention to reduce the installation space of a burner device and/or to improve the operational stability of the burner device, in a cost-effective and simple manner.

The above object is achieved by a burner device with the features of claim 1 and a fuel cell system with the features of claim 15. Further features and details of the invention are disclosed in the dependent claims, the description and the drawings. Naturally, features and details described in connection with the burner device according to the invention also apply in connection with the fuel cell system according to the invention and vice versa, so that with regard to disclosure mutual reference is, or can, always be made to the individual aspects of the invention.

According to the invention, a burner device is provided for a fuel cell system. Such a burner device has a burner housing with a burner inlet for admitting a fuel/air mixture. The burner housing is also equipped with a burner outlet for discharging a burner exhaust gas/air mixture. In addition, the burner device has a catalyst body within the burner housing with a catalyst cavity into which the burner inlet flows. The catalyst body is gas-permeable and is equipped with a catalyst surface which is at least partially provided with a catalytic coating. A bypass volume is thereby formed between the catalyst surface and the burner housing which opens into the burner outlet. The catalyst body has a longitudinal axis, wherein the catalyst surface has a cross-sectional contour which deviates from a circular shape at least in some sections with respect to this longitudinal axis.

A burner device according to the invention differs from the known fuel cell systems in particular in that it has a hybrid combustion functionality. As a hybrid burner device, it serves to provide both flame combustion of the fuel/air mixture and catalytic conversion. In particular, this is based on different operating temperatures so that, at the beginning of the conversion, the catalytic conversion of the fuel/air mixture generates radicals, which in high concentrations in turn improve ignitability in the area of the catalyst surface. As a result, after ignition, both catalytic combustion and flame combustion are in particular operated in parallel, thus allowing the emission of heat to be maximised. This combination of two separate combustion functions in itself allows a significant increase in heat output to be provided under the same or even reduced installation space conditions. The necessary costs and the associated weight can already be significantly reduced through this hybrid design of the burner device.

In order to provide a sufficiently large catalytic surface for ignition of the flame combustion and operation of the catalytic combustion, despite the reduced installation space, according to the invention the catalyst surface is provided with a cross-sectional contour which deviates from the circular shape. This means that, in a sectional representation through the catalyst body transverse to the longitudinal axis, the outline of the catalyst surface represents the cross-sectional contour in this section. While in a purely cylindrical catalyst body a purely circular or substantially circular cross-sectional contour would in this way be formed in the section, according to the invention this cross-sectional contour deviates from the circular shape. Due to the fact that this cross-sectional contour deviates from the circular shape, a catalyst surface is created whose geometric extension is greater than in the case of a cylinder. The greater the deviation of the cross-sectional contour from the circular shape according to the invention, the greater the enlargement factor for the geometric extension of the catalyst surface.

As can be seen from the preceding paragraph, the deviation of the cross-sectional contour from the circular shape thus achieves an enlargement of the catalyst surface with the same or substantially the same volume in relation to a cylindrical catalyst body. In addition to the combination of catalytic and flame combustion in the hybrid mode of operation of the burner device, the catalytic effect is additionally enhanced through an enlargement of the catalyst surface with the same or reduced installation space. In particular, this can involve a significant enlargement by a factor of 2 or more.

To summarise, according to the invention a hybrid combustion functionality is provided which is in addition based on an enlarged catalyst surface, so that as a result an increase in efficiency can be achieved with reduced installation space and maximised heat output.

It should be noted that for the purposes of the present invention a catalytic coating is understood to be a catalytically active material. This catalytically active material serves in particular to generate radicals from the fuel which support or enable flame formation. In particular, a high concentration of such radicals is generated through the catalytic reaction on this catalytic material in order to create an ignition situation in the area of the catalyst surface. A fuel for the purposes of the present invention is in particular a gaseous fuel, i.e. a fuel gas.

The catalyst body is preferably formed with the longitudinal axis as the main extension direction. Basically, this catalyst body can be based on a cylindrical basic shape, wherein the specification of the cross-sectional contour according to the invention is adhered to. The respective cylinder ends of the catalyst body can be closed. These ends can also be both gas-tight and gas-permeable. It is preferred if the main passage direction for the fuel/air mixture runs transversely to the longitudinal axis, i.e. in a radial direction.

It should also be noted that the catalyst body can advantageously be arranged centrally within the burner housing. The central arrangement of the catalyst body leads to the formation of a bypass volume between the catalyst body and the burner housing which is arranged evenly, in particular symmetrically, around the catalyst body. Due to the fact that the bypass volume is able to guide air past the catalyst body, a defined lambda value can be adjusted which provides the desired flame combustion outside of the catalyst body and thus in the bypass volume.

Due to the defined design of the bypass volume described above, it is possible on the one hand to create a defined fuel/air concentration situation for the catalytic combustion and on the other hand a defined air ratio for the flame combustion in the bypass volume. In particular, this is achieved by appropriate control valves, as will be explained in more detail later with reference to examples.

It can bring advantages if, in a burner device according to the invention, the burner housing has an air inlet, in particular separate from the burner inlet, for admitting air into the bypass volume. Of course, air can also be introduced into the bypass volume via other channels. The air inlet can be in fluid-communicating connection with an air source which, as a common air source, also supplies the burner inlet with appropriate air in order to create the fuel/air mixture. In a fuel cell system, the simplest way of achieving this is through an intake of ambient air as an air source.

As will be explained later, introducing air via the separate air inlet allows the air concentration in the bypass volume and thus the stoichiometric ratio to the fuel in the bypass volume to be adjusted. In this way, the desired flame combustion can be more readily controlled and, above all, controlled and/or regulated independently of the catalytic combustion.

It can bring advantages if the air inlet according to the preceding paragraph has a control valve for controlling the mass flow of air into the bypass volume. In particular, such a control valve also allows a complete shut-off and/or a complete opening of the respective air inlet, so that in an extreme position the bypass volume can be completely closed off from the air supply. As soon as the flame combustion has been ignited, the intensity of the flame combustion can be varied via the control valve by varying the stoichiometric ratio in the bypass volume by means of the control valve. This provides a particularly simple and cost-effective control option for controlling the flame combustion separately from the catalytic combustion.

It can bring advantages if, in a burner device according to the invention, an air supply for a controlled supply of air into the burner exhaust gas/air mixture is arranged in and/or after the burner outlet. In particular, this is combined with an air inlet as referred to in the previous paragraph. This can also be an external bypass which is able to guide air completely past the burner device and past both the catalytic and flame combustion. This further increases controllability with regard to the individual gases used and the corresponding gas compositions.

In addition, it brings advantages if, in a burner device according to the invention, the burner inlet, a cavity inlet into the catalyst cavity and/or the catalyst cavity itself has a mixing section for mixing air and fuel. While it is in principle possible to feed the fuel/air mixture to the burner device from outside in premixed form, such a mixing device can also be integrated into the burner device as a mixing section. Such integration allows the mixing to be carried out at the burner inlet, at a cavity inlet and/or integrated in the catalyst cavity, so that it is possible to supply pure or substantially pure fuel and air for this mixing section via external connections on the burner device. This makes it possible to integrate the mixing section into the module of the burner device and even to retrofit existing fuel cell systems with a burner device according to the invention.

It can bring further advantages if, in a burner device according to the invention, the catalyst body is designed for a radial outlet of fuel/air mixture, in particular exclusively for a radial outlet of fuel/air mixture in relation to the longitudinal axis. Such a radial outlet can for example be provided through the porous design of the catalyst body, which will be explained later. However, other gas-permeable structures, for example lattice structures, sponge structures or network structures are of course conceivable in the context of the present invention. For an exclusively radial outlet of the fuel/air mixture, the catalyst body can preferably be sealed in a gas-tight manner at its ends.

A purely radial flow direction through the catalyst body makes it possible to standardise the catalytic combustion situation and in particular to distribute it as evenly as possible over the entire catalyst surface. Since the catalytic combustion functionality serves as the basis for the downstream flame combustion, this also leads to an equalised flame combustion in the bypass volume in the second step.

In addition, it brings advantages if, in a burner device according to the invention, the cross-sectional contour extends between an inner radius and an outer radius, in particular in consistent form in the radial direction and/or the circumferential direction. For example, as will be explained in more detail later, a cross-sectional contour may have a star-shaped design. The cross-sectional contour thus has a maximum radial extension which does not exceed the common outer radius in any radial extension. The minimum radial extension is thereby defined by the common inner radius, so that the star-formed indentations formed in this way all have the same or substantially the same depth. The corresponding surface enlargements resulting from the depressions and elevations, their aerodynamic effect and their catalytic intensification therefore have identical or substantially identical effects for all individual star elements and indentations. As explained in the previous paragraph, a consistent combustion behaviour is thus provided for the hybrid combustion, both in the radial direction and in the circumferential direction.

It is also advantageous if, in a burner device according to the invention, the cross-sectional contour is symmetrical or substantially symmetrical to the longitudinal axis. Such a symmetrical or substantially symmetrical design is to be understood in particular as a point-symmetrical design in the sectional plane transverse to the longitudinal axis and thus to the intersection of the longitudinal axis with this cross-sectional plane. This makes it possible to distinguish such point-symmetrically designed cross-sectional contours from rotationally symmetrical cross-sectional contours of cylindrical catalyst bodies. It should also be noted that the cross-sectional contour can of course vary along the longitudinal axis in the context of the present invention. For example, in addition to a deviation from the circular contour in a cross-section, this cross-sectional contour can be varied along the longitudinal axis so that, for example, the cross-sectional contour has an additional indentation and/or bulge over the course of the longitudinal axis. This can also be referred to as double or additional bulging or curvature, which still further enhances the intensification of the catalytic effect according to the invention by increasing the geometric extension of the catalyst surface.

It may be advantageous if, in a burner device according to the invention, the cross-sectional contour is, at least in some sections, constant or substantially constant along the longitudinal axis. In contrast to the thickness variation described above, this allows a particularly simple and cost-effective possibility for manufacturing the catalyst body. In addition, constant and/or consistent combustion conditions for the hybrid combustion functions are also provided over the course of the longitudinal axis.

It is also advantageous if, in a burner device according to the invention, the cross-sectional contour is, at least in some sections, star-shaped. This is in particular combined with the symmetrical design in relation to the longitudinal axis, which has already been explained several times, so that a point-symmetrical star is provided as a cross-sectional contour. The points of the star define the outer radius and the star valleys the corresponding inner radius. The associated and desired enlargement of the catalytic surface area is provided here with a maximum reduction of the installation space combined with simultaneously increased efficiency of heat generation.

It is further advantageous if, in a burner device according to the invention, the catalyst body is, at least in the region of the catalyst surface, porous, in particular completely or substantially completely porous. A porous formation is to be understood in particular as an at least partially open-pored porosity. Preferably, the open-pored portion of the porous material is in the range of 50 to 100 percent. This means that a permeable pore structure provides the gas-permeability required according to the invention. For example, ceramic materials and/or metal materials can be used. Manufacturing can, for example, involve additive manufacturing processes. Other possible production methods are for example foaming, or coating foams, for example polymer sponges. This results in a porous sponge-like structure which is in particular additionally provided with a catalytically effective coating within the pores.

In a burner device according to the preceding paragraph, it may be advantageous if the catalyst body has a varying porosity along the longitudinal axis. In other words, a different gas-permeability is provided over the course of the longitudinal axis by different porosities. For example, a reduced gas-permeability can be provided at the beginning along the main flow direction within the catalyst cavity and an increasing permeability can be provided over the course of the longitudinal axis. This makes it possible to compensate for pressure differences within the catalyst cavity through a varying gas-permeability, so that an equalisation of the passage of the fuel/air mixture through the catalyst body over the course of the longitudinal axis can preferably be achieved. This too makes it possible to provide a further equalisation of the hybrid combustion functions on the catalyst surface. This variation can for example be achieved through the use of different sintering methods or sintered materials in the production of the catalyst body. The catalyst body can also be composed of disk-like individual elements which have an identical or different porosity for each disk. A combination of different manufacturing options is of course conceivable in the context of the present invention.

It can be advantageous if, in a burner device according to the invention, the catalyst surface has, at least in some sections, a surface normal which intersects an adjacent surface normal of the catalyst surface outside of the catalyst body. This makes it possible to define the cross-sectional contour even more precisely. For example, in this embodiment it is sufficient if the cross-sectional contour deviates so far from the circular shape that two surface normals intersect, from different positions on the catalyst surface, within the bypass volume and thus outside of the catalyst body. As a result, these surface sections of the intersecting surface normals are aligned towards each other. When operating a burner device according to the invention, it is advantageous, among other things, if part of the heat generated by the flame combustion is returned to the catalyst body and in particular to the catalyst surface. Since this is usually primarily effected via thermal radiation, this radiated reflection of the heat can be enhanced through the alignment of the individual surfaces towards each other, as is the case with this embodiment. In other words, in this embodiment it is ensured that in all probability the catalyst surface will continue to be supplied with heat through flame combustion. This heat supply ensures that the catalyst surface does not cool down in an undesirable way but continues to provide the radicals required for stable flame combustion through the catalytic conversion.

It also brings advantages if, in a burner device according to the preceding paragraph, the catalyst surface has, at least in some sections, a surface normal which intersects the catalyst surface in an adjacent section. This further accentuates the indentation according to the preceding paragraph, so that the surface normal not only intersects an adjacent surface normal, but directly intersects an adjacent surface section of the catalyst surface, so that the reflection of heat and thus its transmission back from the flame zone is further intensified.

It also brings advantages if, in a burner device according to the invention, the catalyst surface has at least one guide section for guiding the air in the bypass volume which in particular extends along or substantially along the longitudinal axis. Such a guide section can also be referred to as a guide fin and extends in particular along the flow direction of the air in the bypass volume. In addition to the improved catalytic combustion function, this makes it possible to provide a flow optimisation through the cross-sectional contour. Air in the bypass is protected against turbulence in that such a fin-like structure, as a guide section, guides the air flow and preferably protects against turbulence in the region of a flame zone above the catalyst surface. The stability of the flame combustion can be even further improved in this way. In addition, this defined geometric guidance function for the air in the bypass volume allows improved mixing above the catalyst surface.

Another object of the present invention is a fuel cell system for generating electrical energy from a fuel and/or for generating fuel from electrical energy, comprising at least one burner device according to the invention. Thus, a fuel cell system according to the invention brings the same advantages as have been explained in detail with reference to a burner device according to the invention. Such a fuel cell system thus serves, for example as an SOFC fuel cell system, to generate electrical energy from a gaseous fuel. Conversely, such a fuel cell system can also produce a fuel from electrical energy, for example as an SOEC fuel cell system. In both modes of operation, it is necessary to achieve an operating temperature in order to start up the fuel cell system, so that a burner device according to the invention can bring the advantages explained in detail for such a fuel cell system.

Further advantages, features and details of the invention are explained in the following description, in which exemplary embodiments of the invention are described in detail with reference to the drawings. In each case schematically:

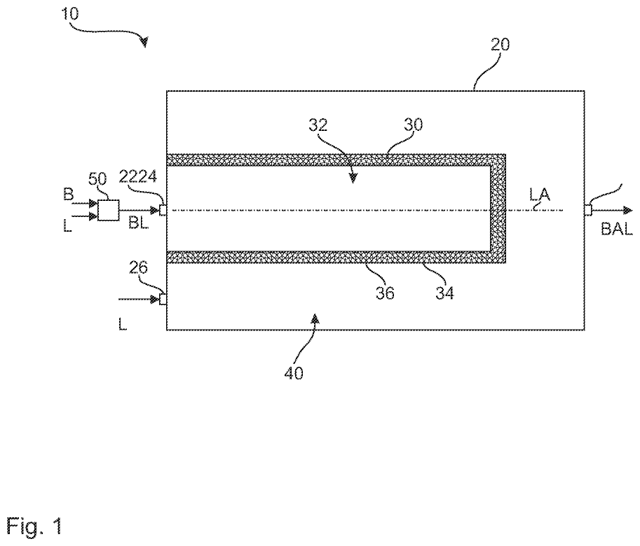

FIG. 1 shows an embodiment of a burner device according to the invention,

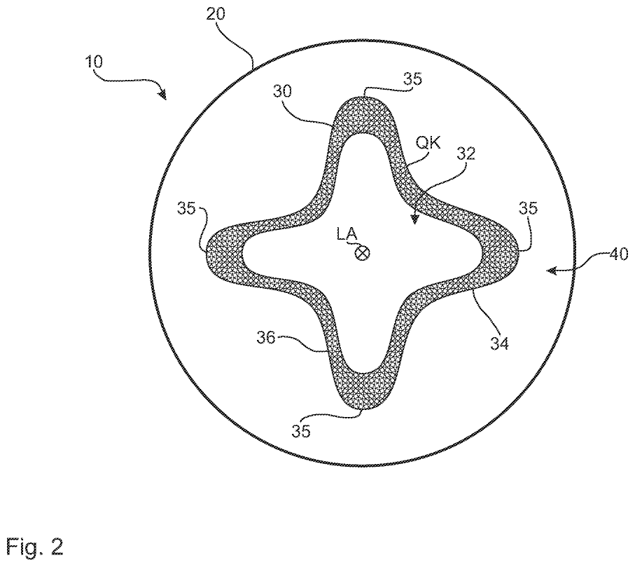

FIG. 2 shows a further embodiment of a burner device according to the invention,

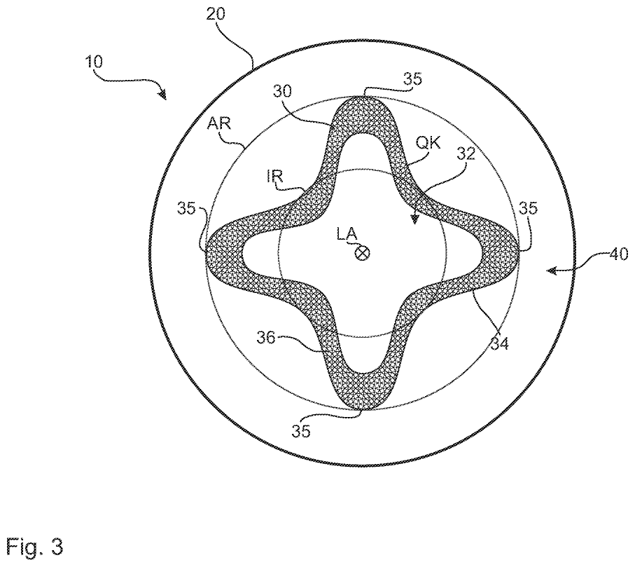

FIG. 3 shows a further embodiment of a burner device according to the invention,

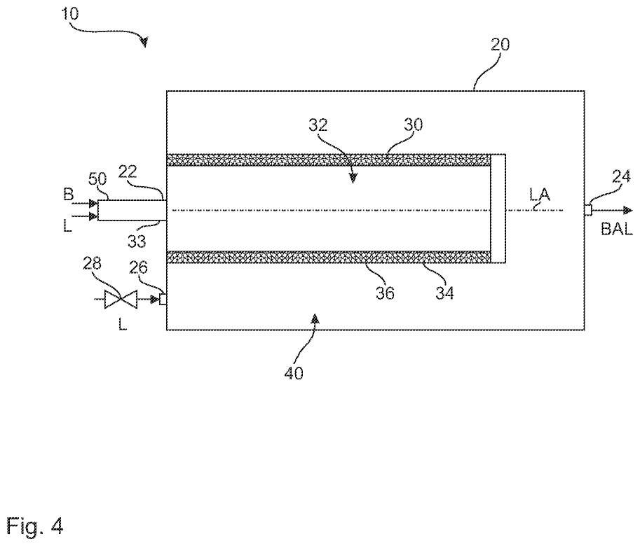

FIG. 4 shows a further embodiment of a burner device according to the invention,

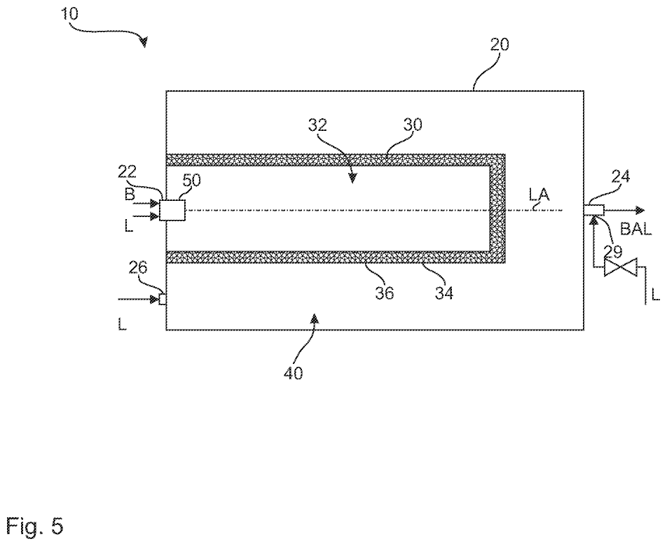

FIG. 5 shows a further embodiment of a burner device according to the invention,

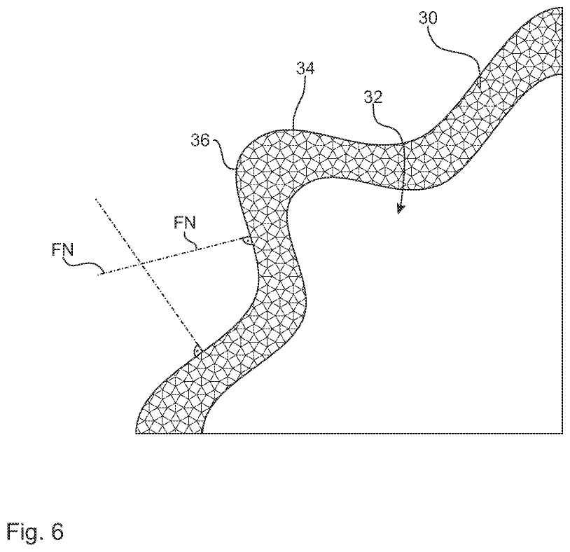

FIG. 6 shows a possible partial cross-section through a catalyst body,

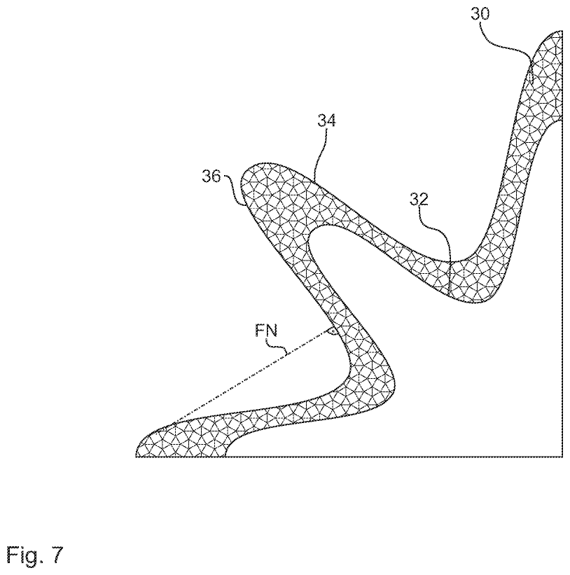

FIG. 7 shows a possible partial cross-section through a further catalyst body,

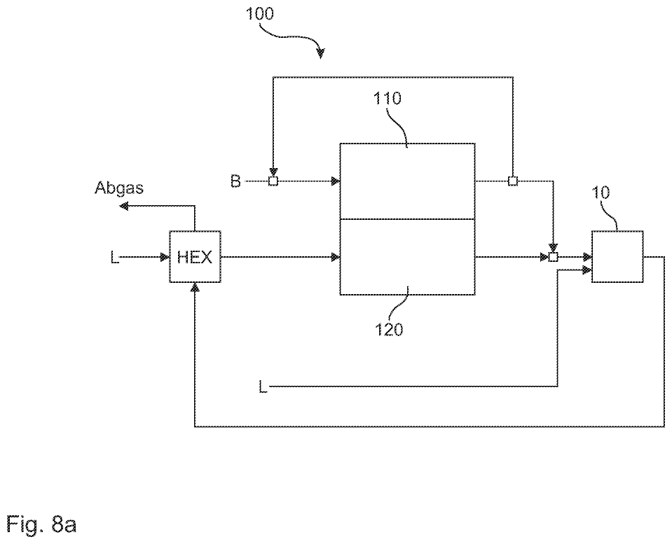

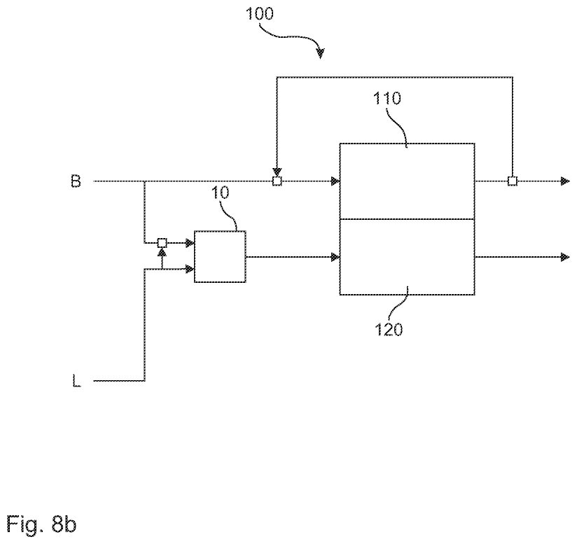

FIG. 8a shows a schematic representation of a fuel cell system according to the invention and

FIG. 8b shows a further schematic representation of a fuel cell system according to the invention.

FIG. 1 shows schematically a burner device 10 in a lateral cross-section along the longitudinal axis LA. This has two main elements. On the one hand there is the burner housing 20, in which the second main component is arranged in the form of the catalyst body 30. In the embodiment shown in FIG. 1, a fuel/air mixture BL can be introduced into the catalyst cavity 32 via the burner inlet 22. In order to produce the fuel/air mixture BL, a mixing section 50 is provided upstream of the burner inlet 22 which is supplied with fuel B and air L. The fuel/air mixture BL thus penetrates via the burner inlet 22 into the burner housing 20 and in particular into the catalyst cavity 32.

In addition, it can be seen in FIG. 1 that air L is introduced into the bypass volume 40 via an air inlet 26. A mixture of burner exhaust gas and air L forms as a burner exhaust gas/air mixture BAL, which leaves the bypass volume 40 again via the burner outlet 24.

In terms of its operating principle, the burner device 10 can be described as a hybrid burner. The fuel/air mixture BL penetrates the gas-permeable porous catalyst body 30 and reaches the catalyst surface 34, which has a catalytic coating 36. Due to the catalytic coating, a reaction of the fuel B is possible, so that radicals are formed which in turn allow a flame combustion of the remaining fuel B with the air L in the bypass volume 40. The resulting waste heat is discharged from the burner device 10, via the burner exhaust gas/air mixture BAL, via the burner outlet 24 and supplied to the other components of the fuel cell system 100.

FIG. 2 shows a cross-sectional contour QC of the catalyst body 30 according to the invention in a schematic cross-section transverse to the longitudinal axis LA. Four indentations are shown here which cause the cross-sectional contour QC to deviate from the circular shape. The catalyst cavity 32 is similarly designed, so that the fuel/air mixture BL passes radially through the porous catalyst body 30 to the corresponding indentations and bulges of the catalyst surface 34 and thus to the catalytic coating 36 thereon. FIG. 2 also shows that the four bulges, as fin-like guide sections 35 extending along the longitudinal axis LA, serve to guide the air L in the bypass volume 40.

FIG. 3 shows the embodiment from FIG. 2, but in relation to an inner radius IR and an outer radius AR. While basically any cross-sectional contour QC is possible, also an asymmetrical one, as long as it deviates from the circular shape, a regular design as shown in FIGS. 2 and 3 is advantageous. As can be seen here, the regular cross-sectional contour QC in this embodiment is oriented on a maximum outer radius AR and a minimum inner radius IR, so that the corresponding hybrid combustion functionalities in the circumferential direction and radial direction are comparable.

FIG. 4 shows a further embodiment of such a burner device 10. It differs from the variant of FIG. 1 in that the air supply into the bypass volume 40 can be regulated or controlled by means of a control valve 28. This makes it possible to adjust the stoichiometric ratio in the bypass volume 40 precisely and thus to control the combustion functionalities of the flame combustion even more precisely. It can also be seen in FIG. 4 that the mixing section 50 is integrated into a cavity inlet 33 of the burner inlet 22. Thus, the fuel/air mixture BL is formed directly at the inlet into the catalyst cavity 32, so that the overall system of the burner device 10 can be made even more compact in design. Furthermore, it can be seen in FIG. 4, by way of example, how the right-hand end face of the catalyst body 30 is designed to be gas-tight. This makes it possible to limit the catalytic effect to the circumferential surface of the catalyst body 30, which leads to an equalisation of the combustion functions.

FIG. 5 shows another embodiment of the burner device 10. Here, a mixing section 50 is integrated into the burner inlet 22 and protrudes into the catalyst cavity 32. This maximises the compact design of the burner device 10. In this embodiment too, an additional air supply 29 into the burner outlet 24 can be seen which allows air L to be added to the burner exhaust-air mixture via a control valve. This makes it possible on the one hand to influence the outlet temperature of the burner exhaust gas/air mixture BAL, but also to influence its stoichiometric ratio subsequently outside of the burner device 10.

FIG. 6 shows a further possibility of shaping the catalyst body 30. Here, the surface normal FN is shown at two positions of the catalyst surface 34. The two surface normals FN shown intersect outside of the catalyst body 30, so that a flame zone is formed between these two elevations in the indentation of the catalyst body 30. In this flame zone, flame-combusted fuel causes heat transmitted by radiation to reach an increased absorption area of the catalyst body 30 compared to the circular shape. The corresponding amount of heat reflected by thermal radiation is thus increased compared to a circular catalyst body 30.

FIG. 7 shows a further intensification of the above effect as a result of a further adapted cross-sectional contour QC. Here, the surface normal FN is aligned through the pronounced indentation of the catalyst body 30 in such a way that it directly intersects an adjacent section of the catalyst body 30. This maximises the reflection by thermal radiation explained in the preceding paragraph with reference to FIG. 6.

FIGS. 8a and 8b schematically show a fuel cell system 100, wherein here the fuel cell stack schematically comprises an anode section 110 and a cathode section 120. The supply to the cathode section 120 in FIG. 8b and the discharge from the cathode section 120 and from the anode section 110 in FIG. 8a are equipped with a burner device 10 which brings the advantages according to the invention. In FIG. 8a, a heat exchanger HEX is arranged in the supply of air L to the cathode section 120, which gives off waste heat from the cathode exhaust gas to the supplied air L before the exhaust gas is released into the environment.

The preceding explanation describes the present invention exclusively with reference to examples.

### LIST OF REFERENCE SIGNS

10 burner device
20 burner housing
22 burner inlet
24 burner outlet
26 air inlet
28 control valve
29 air supply
30 catalyst body
32 catalyst cavity
33 cavity inlet
34 catalyst surface
35 guide section
36 catalytic coating
40 bypass volume
50 mixing section
100 fuel cell system
110 anode section
120 cathode section
HEX heat exchanger
L air
B fuel
BL fuel/air mixture
BAL burner exhaust gas/air mixture
LA longitudinal axis
QK cross-sectional contour
IR inner radius
AR outer radius
FN surface normal

1. The burner device for a fuel cell system, having a burner housing with a burner inlet for admitting a fuel/air mixture (BL) and a burner outlet for discharging a burner exhaust gas/air mixture (BAL), further comprising a catalyst body within the burner housing with a catalyst cavity into which the burner inlet opens, wherein the catalyst body is gas-permeable and has a catalyst surface with an at least partly catalytic coating, wherein a bypass volume is formed between the catalyst surface and the burner housing said bypass volume opening into the burner outlet, wherein the catalyst body further comprises a longitudinal axis (LA), and the catalyst surface has a cross-sectional contour (QK) which deviates from a circular shape at least in some sections with respect to this longitudinal axis (LA).

2. Burner device according to claim 1, wherein the burner housing has an air inlet, in particular separate from the burner inlet, for admitting air into the bypass volume.

3. Burner device according to claim 2, wherein the air inlet has a control valve for controlling the mass flow of air into the bypass volume.

4. Burner device according to claim 1, wherein an air supply for a controlled supply of air (L) into the burner exhaust gas/air mixture (BAL) is arranged in and/or after the burner outlet.

5. Burner device according to claim 1, wherein the burner inlet, a cavity inlet in the catalyst cavity and/or the catalyst cavity have a mixing section for mixing air (L) and fuel (B).

6. Burner device according to claim 1, wherein the catalyst body is designed for a radial outlet of fuel/air mixture (BL) in relation to the longitudinal axis (LA), in particular exclusively for a radial outlet of fuel/air mixture (BL) in relation to the longitudinal axis (LA).

7. Burner device according to claim 1, wherein the cross-sectional contour (QK) extends between an inner radius (IR) and an outer radius (AR), in particular in an unified form in radial direction and/or in circumferential direction.

8. Burner device according to claim 1, wherein the cross-sectional contour (QK) is symmetrical or substantially symmetrical to the longitudinal axis (LA).

9. Burner device according to claim 1, wherein the cross-sectional contour (QK) is, at least in some sections, constant or substantially constant along the longitudinal axis (LA).

10. Burner device according to claim 1, wherein the cross-sectional contour (QK) is, at least in some sections, star-shaped.

11. Burner device according to claim 1, wherein the catalyst body is, at least in the region of the catalyst surface, porous, in particular completely or substantially completely porous.

12. Burner device according to claim 11, wherein the catalyst body has a varying porosity along the longitudinal axis (LA).

13. Burner device according to claim 1, wherein the catalyst surface has, at least in some sections, a surface normal (FN) which intersects an adjacent surface normal (FN) of the catalyst surface outside of the catalyst body.

14. Burner device according to claim 1, wherein the catalyst surface has at least in some sections, a surface normal (FN) which intersects the catalyst surface in an adjacent section.

15. Burner device according to claim 1, wherein the catalyst surface has at least one guide section for guiding the air in the bypass volume which in particular extends along or substantially along the longitudinal axis (LA).

16. Fuel cell system for generating electrical energy from a fuel and/or for generating fuel from electrical energy, comprising at least one burner device with the features of claim 1.
